(19) United States
(12) Patent Application Publication
(10) Pub. No.: US 2019/0123445 A1
(43) Pub. Date: Apr. 25, 2019

(54) ELECTRONIC DEVICE

(71) Applicant: PEGATRON CORPORATION, Taipei City (TW)

(72) Inventors: Hsiao-Wen Wu, Taipei City (TW); Chin-Ting Huang, Taipei City (TW); Shih-Sheng Lin, Taipei City (TW)

(73) Assignee: PEGATRON CORPORATION, TAIPEI CITY (TW)

(21) Appl. No.: 16/109,554

(22) Filed: Aug. 22, 2018

(30) Foreign Application Priority Data
Oct. 23, 2017 (TW) 106136393

(51) Int. Cl. H01Q 9/16

(52) U.S. Cl. CPC H01Q 9/16; H01Q 23/00

(57) ABSTRACT

An electronic device including a casing, a circuit board and a dipole antenna structure is provided. The circuit board is disposed in the casing and includes a ground end. The dipole antenna structure is disposed in the casing and includes a feeding end, a first radiator and a second radiator. The first radiator is connected to the feeding end, and the second radiator is connected to the ground end. The first radiator and the second radiator are mirror symmetrical to each other with respect to the feeding end. A length of a short side of the circuit board is less than a length of the first radiator, and the length of the short side of the circuit board is less than a length of the second radiator.

### CROSS-REFERENCE TO RELATED APPLICATION

This application claims the priority benefit of Taiwan application serial no. 106136393, filed on Oct. 23, 2017. The entirety of the above-mentioned patent application is hereby incorporated by reference herein and made a part of this specification.

### BACKGROUND

### Technical Field

The disclosure relates to an electronic device, and particularly relates to an electronic device with an antenna.

### Description of Related Art

With the rapid development of the communications industry, novel communication technologies (the operating frequency band thereof is, for example, in a range of 700 MHz to 900 MHz) have been proposed to enable electronic devices to achieve long-distance data exchange. However, since some electronic devices (e.g., wearable electronic devices and so on) are often smaller in size, how to dispose an antenna capable of supporting a specific frequency band in this kind of small-sized electronic devices is currently a major challenge in the antenna design.

### SUMMARY

The disclosure provides an electronic device that has an antenna structure capable of supporting a specific frequency band on the premise of small volume.

An electronic device of this disclosure includes a casing, a circuit board and a dipole antenna structure. The circuit board is disposed in the casing and includes a ground end. The dipole antenna structure is disposed in the casing and includes a feeding end, a first radiator and a second radiator. Herein the first radiator is connected to the feeding end, the second radiator is connected to the ground end, and the first radiator and the second radiator are mirror symmetrical to each other with respect to the feeding end. Herein a length of a short side of the circuit board is less than a length of the first radiator, and the length of the short side length of the circuit board is less than a length of the second radiator.

In an embodiment of the disclosure, the first radiator and the second radiator jointly surround at least three sides of the circuit board.

In an embodiment of the disclosure, the first radiator and the second radiator jointly form a U-shape.

In an embodiment of the disclosure, the first radiator and the second radiator individually have a plurality of bends.

In an embodiment of the disclosure, the electronic device further includes an appearance member disposed on the casing and exposed outside the casing. The first radiator and the second radiator extend from the casing to the appearance member.

In an embodiment of the disclosure, the appearance member is a buckle, a ring or a decorative component.

In an embodiment of the disclosure, a length of the casing is less than the length of the first radiator, and the length of the casing is less than the length of the second radiator.

In an embodiment of the disclosure, any side of the circuit board is less than 10 centimeters in length.

In an embodiment of the disclosure, a frequency band is obtained by the first radiator resonating with the second radiator, and each of the length of the first radiator and the length of the second radiator is a ¼ wavelength of the frequency band.

In an embodiment of the disclosure, the frequency band is LTE band 12 or LTE band 17.

Based on the foregoing, the electronic device in this disclosure is smaller in size (so as to have a small-sized circuit board). If other types of antenna are used, it would be rather difficult to design an antenna structure in such a small-sized electronic device since a large-area ground plane needs to be additionally provided. By comparison, in the electronic device of this disclosure, the dipole antenna structure is used instead. In this case, since the ground end of the circuit board is used as the ground end for the dipole antenna structure, the electronic device does not need a large-area ground plane additionally provided with, and the device may thus maintain small volume. In other words, the electronic device in this disclosure has an antenna structure capable of supporting a specific frequency band (e.g., in a range of 700 MHz to 900 MHz) on the premise of small volume.

To make the aforementioned features and advantages of the disclosure more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic view showing an electronic device according to an embodiment of the disclosure.

FIG. 2 is a schematic view showing an electronic device according to another embodiment of the disclosure.

FIG. 3 is a schematic view showing an electronic device according to another embodiment of the disclosure.

FIG. 4 is a schematic view showing an electronic device according to another embodiment of the disclosure.

FIG. 5 is a simulation diagram of frequency-reflection coefficient for the electronic device of FIG. 1.

FIG. 6 is a simulation diagram of frequency-antenna efficiency for the electronic device of FIG. 1.

### DESCRIPTION OF THE EMBODIMENTS

In this embodiment, an electronic device 100 is exemplified by a wearable electronic device. The electronic device 100 is, for example, a body of an electronic watch. However, the type of the electronic device 100 is not limited thereto. In other embodiments, the electronic device 100 may also be an electronic wristband, an electronic necklace, or another small-sized electronic device.

Generally speaking, the length of an antenna structure is related to the wavelength of the frequency band that the antenna structure resonates. As current electronic devices are gradually reduced in volume, it is not easy to dispose an antenna structure with a low frequency band in such small volume. The reason lies in that planar inverted-F antennas (PIFA) or monopole antennas commonly used nowadays require large-sized ground planes, and it is difficult to insert such kind of antenna structures into small-sized electronic devices. By comparison, the electronic device 100 of this embodiment provides an antenna structure that can be used in a small-sized electronic device and obtain a low frequency band by resonance. The details thereof are described hereinafter.

FIG. 1 is a schematic view showing an electronic device according to an embodiment of the disclosure. With reference to FIG. 1, the electronic device 100 of this embodiment includes a casing 110, a circuit board 120, a dipole antenna structure 130 and a battery 150. The circuit board 120 is disposed in the casing 110 and includes a ground end 122. The circuit board 120 is provided with electronic components and traces thereon that allow the electronic device 100 to perform corresponding functions. The battery 150 is adapted to supply power to the circuit board 120. The dipole antenna structure 130 is disposed in the casing 110 and includes a feeding end 132, a first radiator 134 and a second radiator 136. The dipole antenna structure 130 is an antenna structure with a mirror symmetrical form. As shown in FIG. 1, the first radiator 134 and the second radiator 136 are symmetrical with respect to the feeding end 132. In this embodiment, the upper and lower portions of the casing 110 are also symmetrical in shape with respect to the feeding end 132. Therefore, the first radiator 134 and the second radiator 136 are distributed in the casing 110 symmetrically. However, the shape of the casing 110 is surely not limited thereto.

In this embodiment, the first radiator 134 of the dipole antenna structure 130 is connected to the feeding end 132, and the second radiator 136 of the dipole antenna structure 130 is connected to the ground end 122 of the circuit board 120. That is, in this embodiment, the ground end 122 of the circuit board 120 is used as the ground end for the dipole antenna structure 130. Consequently, the electronic device 100 does not need an additional large-area ground plane disposed, and the device may thus maintain small volume.

As shown in FIG. 1, in this embodiment, the volume of the electronic device 100 is relatively small. More specifically, the length of a long side of the circuit board 120 is less than the length of the first radiator 134, and the length of the long side of the circuit board 120 is less than the length of the second radiator 136. In this embodiment, even the length of the casing 110 is less than the length of the first radiator 134 and less than the length of the second radiator 136. Such length relationship allows the first radiator 134 and the second radiator 136 to surround at least three sides of the circuit board 120. Surely, in other embodiments, as long as the length of a short side of the circuit board 120 is less than the length of the first radiator 134; the length of the short side of the circuit board 120 is less than the length of the second radiator 136; and the feeding end 132 is located at the short side of the circuit board 120, the first radiator 134 and the second radiator 136 may surround at least three sides of the circuit board 120. It should be noted that FIG. 1 merely illustrates an embodiment of the disclosure as long as each of the lengths of the first radiator 134 and the second radiator 136 is greater than the short side length of the circuit board 120.

In this embodiment, a frequency band is obtained by the first radiator 134 resonating with the second radiator 136. The frequency band is, for example, LTE band 12 (699 MHz-716 MHz) or LTE band 17 (704 MHz-716 MHz). The lengths of the first radiator 134 and the second radiator 136 are related to the wavelength of the coupled frequency band, and in the case of the dipole antenna structure 130, the resonance length that activates a resonance mode is ½ wavelength of the frequency band. Therefore, in this embodiment, each of the length of the first radiator 134 and the length of the second radiator 136 is ¼ wavelength of the frequency band, and each is about 10 centimeters or so.

For the small-sized electronic device 100 of this embodiment (e.g., the body of the electronic watch), because the lengths of the first radiator 134 and the second radiator 136 are greater than the length of the circuit board 120 and even greater the length of the casing 110, the first radiator 134 and the second radiator 136 jointly surround the three sides of the circuit board 120 (the left side, the upper side and the bottom side in FIG. 1), which makes the first radiator 134 and the second radiator 136 jointly form a U-shape. However, the shapes of the first radiator 134 and the second radiator 136 are surely not limited thereto.

It should be noted that although the foregoing description mainly refers to the low frequency band, the structure recited in this embodiment (i.e., application of the dipole antenna structure 130 in a small volume electronic device) may be applied to a high frequency band. Since the wavelength of the high frequency band is shorter the required antenna length is shorter correspondingly. Thus, the configuration thereof is even simpler. That is, the structure recited in this embodiment is not only applicable to the low frequency band but also applicable to the high frequency band.

Embodiments of other electronic devices 100a, 100b and 100c are described hereinafter. It should be noted that in the following embodiments, the same or similar components as those of the previous embodiment are assigned with the same or similar reference numerals, and details thereof will not be repeated. Only the major differences are described below.

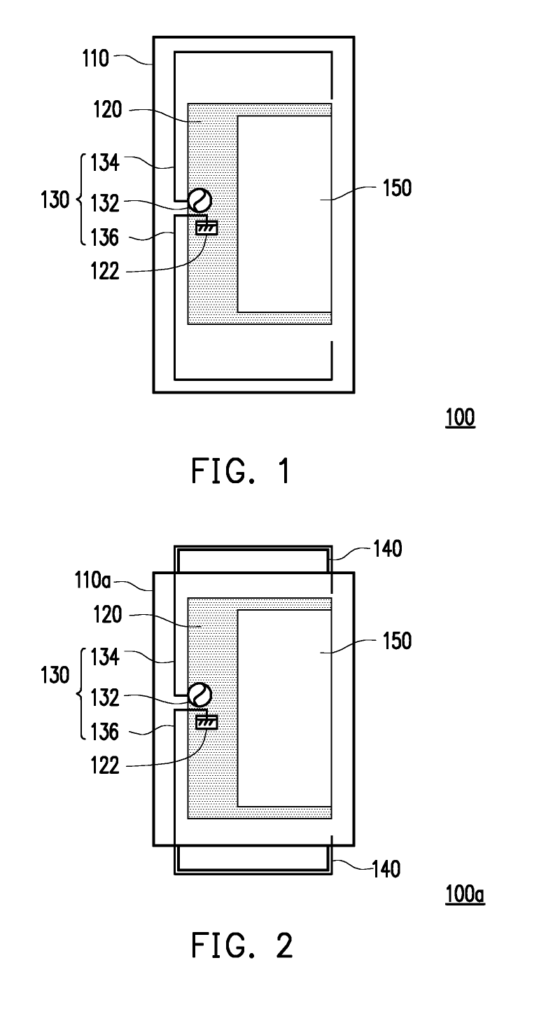

FIG. 2 is a schematic view showing an electronic device according to another embodiment of the disclosure. With reference to FIG. 2, since main casings of some electronic devices are even smaller in size, such electronic devices may have appearance members such as buckles, rings or decorative components on the outside as an extension of the casing. In this embodiment, an electronic device 100a further includes an appearance member 140 disposed on a casing 110a and exposed outside the casing 110a. The appearance member 140 is, for example, a buckle, a ring or a decorative component, but the type, shape and material of the appearance member 140 are not limited thereto.

In this embodiment, although the volume of the casing 110a is less than the volume of the casing 110 of FIG. 1, by the configuration of the appearance member 140, a first radiator 134 and a second radiator 136 extend from the casing 110a to the appearance member 140. The electronic device 100a may still provide sufficient space for disposing the first radiator 134 and the second radiator 136.

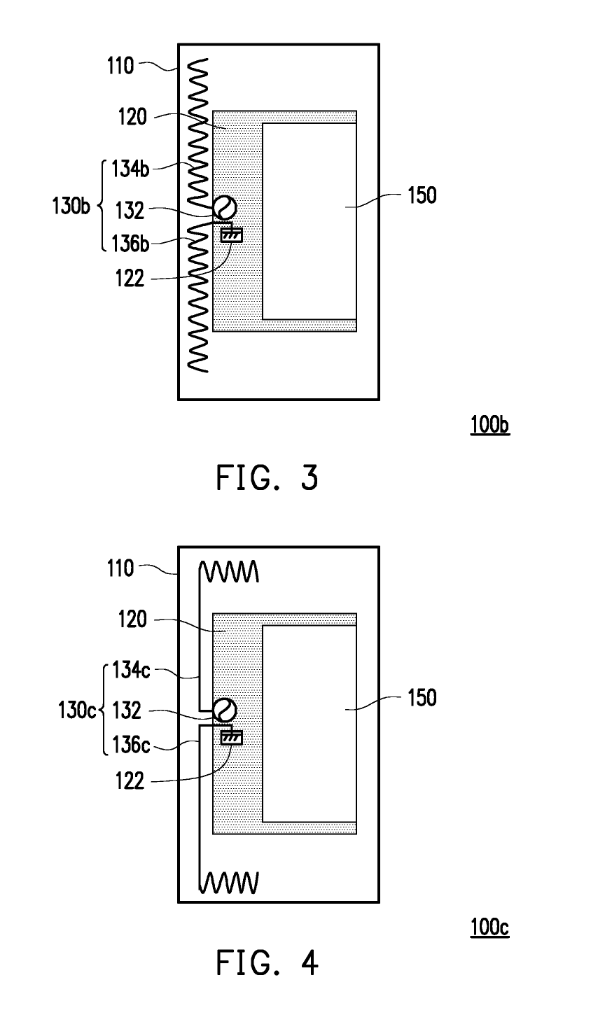

FIG. 3 is a schematic view showing an electronic device according to another embodiment of the disclosure. With reference to FIG. 3, a primary difference between a dipole antenna structure 130b of FIG. 3 and the dipole antenna structure 130 of FIG. 2 lies in the shapes of a first radiator 134b and a second radiator 136b. In this embodiment, each of the first radiator 134b and the second radiator 136b that are located besides one of the sides of a circuit board 120 has a plurality of bends. That is, if there is sufficient space besides any side of the circuit board 120, the first radiator 134b and the second radiator 136b may also be disposed there in a curved form or the like. In FIG. 1, the first radiator 134 and the second radiator 136 are curved along the periphery of the circuit board 120 and disposed on three sides of the circuit board 120. In this embodiment, because of the shape designs of the first radiator 134b and the second radiator 136b, the first radiator 134b and the second radiator 136b may be disposed on only one side of the circuit board 120.

Surely, the shapes and configuration positions of the dipole antenna structures 130, 130a and 130b are not limited thereto. FIG. 4 is a schematic view showing an electronic device according to another embodiment of the disclosure. With reference to FIG. 4, each of a first radiator 134c and a second radiator 136c of a dipole antenna structure 130c in FIG. 4 has some sections made of a straight line and some sections made of a curved line. That is, different sections of the first radiator 134c and the second radiator 136c may be of different types.

In the foregoing embodiments, the first radiators 134, 134a, 134b and 134c and the second radiators 136, 136a, 136b and 136c capable of generating the same frequency bands by resonance have the same length. However, the first radiators 134, 134a, 134b and 134c and the second radiators 136, 136a, 136b and 136c may be disposed in the electronic devices 100, 100a, 100b and 100c by different patterning layouts. In other words, for electronic devices in different shapes or sizes, it is possible to design a first radiator and a second radiator in correspondence with the shapes in their inner spaces.

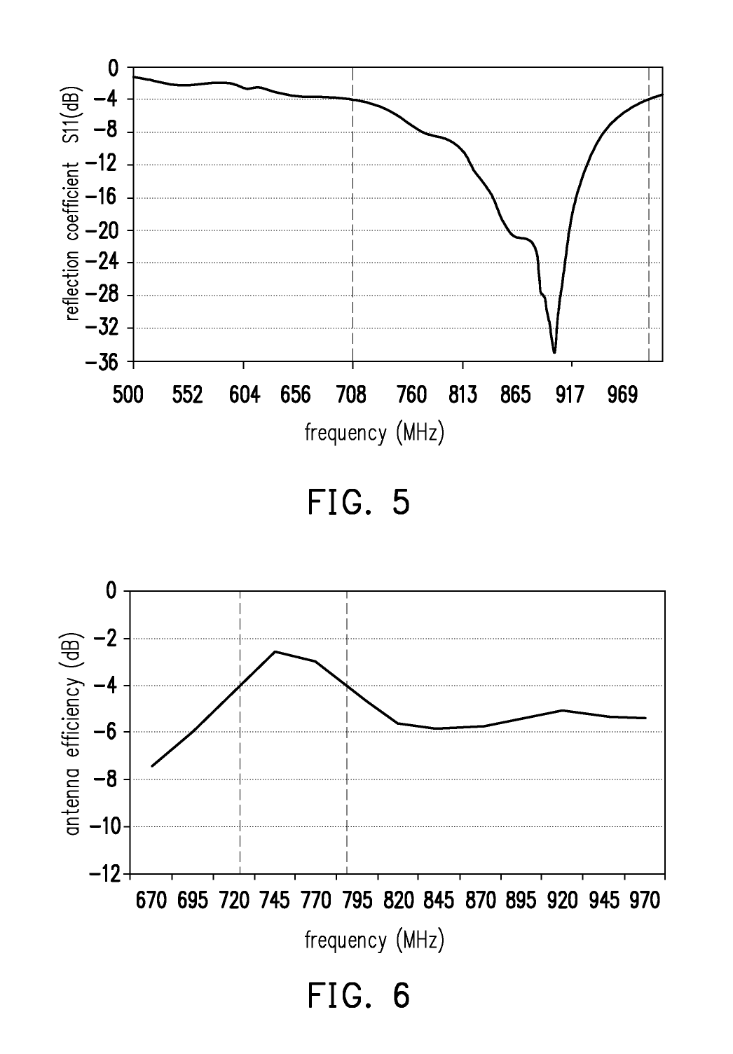

FIG. 5 is a simulation diagram of frequency-reflection coefficient for the electronic device of FIG. 1. Please refer to FIG. 5, in which the dipole antenna structure 130 of FIG. 1 is used for simulation. If the reflection coefficient of −4 dB is the norm, the reflection coefficient lower than −4 dB has better performance. As shown in FIG. 5, the frequency that the dipole antenna structure 130 of FIG. 1 generates has better performance on reflection coefficient in a range from around 708 MHz to 969 MHz, covering part of the required bandwidth of LTE band 12 (699 MHz-716 MHz), part of the required bandwidth of LTE band 17 (704 MHz-716 MHz), and part of the required bandwidth of LTE band 5 (824 MHz-849 MHz) so that better performance in LTE low frequency is attained for the dipole antenna structure 130.

FIG. 6 is a simulation diagram of frequency-antenna efficiency for the electronic device of FIG. 1. Please refer to FIG. 6, in which the dipole antenna structure 130 of FIG. 1 is used for simulation. If the antenna efficiency of −4 dB is the noun, the antenna efficiency higher than −4 dB has a better performance. Then, better antenna efficiency performance approximately falls in a range of 710 MHz to 780 MHz, covering part of the required bandwidth of LTE band 12 (699 MHz-716 MHz) and part of the required bandwidth of LTE band 17 (704 MHz-716 MHz), so that a good LTE low frequency performance is attained for the dipole antenna structure 130.

In summary of the foregoing, the electronic device in this disclosure is smaller in size (so as to have a small-sized circuit board). Compared to other types of antenna, a large-area ground plane would be additionally required. It is rather difficult to design an antenna structure in such a small-sized electronic device. By comparison, in the electronic device of this disclosure, the dipole antenna structure is used instead. In this case, since the ground end of the circuit board is used as the ground end for the dipole antenna structure, the electronic device does not need an additional large-area ground plane, and the device may thus maintain small volume. In other words, the electronic device in this disclosure has an antenna structure capable of supporting a specific frequency band (e.g., in a range of 700 MHz to 900 MHz) on the premise of small volume.

Although the embodiments are already disclosed as above, these embodiments should not be construed as limitations on the scope of the disclosure. It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An electronic device, comprising:
a casing;
a circuit board disposed in the casing and comprising a ground end; and
a dipole antenna structure disposed in the casing and comprising a feeding end, a first radiator and a second radiator, wherein the first radiator is connected to the feeding end, the second radiator is connected to the ground end, and the first radiator and the second radiator are mirror symmetrical to each other with respect to the feeding end, wherein a length of a short side of the circuit board is less than a length of the first radiator, and the length of the short side of the circuit board is less than a length of the second radiator.

2. The electronic device as recited in claim 1, wherein the first radiator and the second radiator jointly surround at least three sides of the circuit board.

3. The electronic device as recited in claim 1, wherein the first radiator and the second radiator jointly form a U-shape.

4. The electronic device as recited in claim 1, wherein the first radiator and the second radiator individually have a plurality of bends.

5. The electronic device as recited in claim 1, further comprising:
an appearance member disposed on the casing and exposed outside the casing, wherein the first radiator and the second radiator extend from the casing to the appearance member.

6. The electronic device as recited in claim 5, wherein the appearance member is a buckle, a ring or a decorative component.

7. The electronic device as recited in claim 1, wherein a length of the casing is less than the length of the first radiator, and the length of the casing is less than the length of the second radiator.

8. The electronic device as recited in claim 1, wherein any side of the circuit board is less than 10 centimeters in length.

9. The electronic device as recited in claim 1, wherein a frequency band is obtained by the first radiator resonating with the second radiator, and each of the length of the first radiator and the length of the second radiator is a ¼ wavelength of the frequency band.

10. The electronic device as recited in claim 9, wherein the frequency band is LTE band 12 or LTE band 17.
